(19) United States
(12) Patent Application Publication
(10) Pub. No.: US 2021/0103977 A1
(43) Pub. Date: Apr. 8, 2021

(54) VEHICLE RENTAL SYSTEM

(71) Applicant: TOYOTA JIDOSHA KABUSHIKI KAISHA, Toyota-shi (JP)

(72) Inventors: Ryosuke TANIMURA, Nisshin-shi (JP); Isao SATO, Nagoya-shi (JP); Yusuke SHIBANO, Nagakute-shi (JP); Takeshi OZAKI, Nagoya-shi (JP); Daiki KANEICHI, Nisshin-shi (JP); Toshiyuki TONUMA, Nisshin-shi (JP); Koichi NUMATA, Shimada-shi (JP); Hiroki IIDA, Toyota-shi (JP)

(21) Appl. No.: 16/995,938

(22) Filed: Aug. 18, 2020

(30) Foreign Application Priority Data
Oct. 2, 2019 (JP) 2019-181864

(51) Int. Cl. G06Q 30/06

(52) U.S. Cl. CPC G06Q 30/0645; G06Q 30/0631

(57) ABSTRACT

A vehicle rental system includes an input acceptance unit that accepts input of usage information on use of a vehicle by a user, a selection unit that selects a type of the vehicle, from among an electric vehicle and a fuel cell vehicle, which is recommended for the user according to the usage information accepted by the input acceptance unit, and a notification unit that notifies the user of the type of the vehicle selected by the selection unit.

### INCORPORATION BY REFERENCE

This application claims priority to Japanese Patent Application No. 2019-181864 filed on Oct. 2, 2019, incorporated herein by reference in its entirety.

### BACKGROUND

### 1. Technical Field

The present disclosure relates to a vehicle rental system.

### 2. Description of Related Art

A system for renting an electric vehicle to a user in which the vehicle is rented out based on reservation information including a usage unit received from a user terminal and vehicle information from each vehicle, is already well-known (for example, refer to Japanese Unexamined Patent Application Publication No. 2012-083905 (JP 2012-083905 A)).

### SUMMARY

In recent years, zero emission vehicles that do not emit exhaust gas have been promoted in order to protect the global environment. The zero emission vehicles can be mainly divided into two types: electric vehicles and fuel cell vehicles. These two types of vehicles have different performances such as travel distance and a maximum output when fully charged. It is difficult for users and employees of rental companies that rent out vehicles to accurately understand these differences in performance. Therefore, there is a demand for technology capable of recommending a vehicle, either an electric vehicle or a fuel cell vehicle, which is suitable for a specific user, based on usage information on use of a vehicle by a user.

The present disclosure can be implemented by the following embodiments.

(1) According to one aspect of the present disclosure, a vehicle rental system is provided. The vehicle rental system includes an input acceptance unit that accepts input of usage information on use of a vehicle by a user, a selection unit that selects a type of the vehicle, from among an electric vehicle and a fuel cell vehicle, which is recommended for the user according to the usage information accepted by the input acceptance unit, and a notification unit that notifies the user of the type of the vehicle selected by the selection unit. With this aspect, the selection unit selects the type of the vehicle, from among the electric vehicle and the fuel cell vehicle, which is recommended for the user according to the usage information accepted by the input acceptance unit, thereby recommending the appropriate type of vehicle to the user according to the usage information.

(2) In the above aspect, the usage information may include route information on a predicted travel route of the vehicle, and the selection unit may predict a travel distance of the vehicle using the predicted travel route, and select the fuel cell vehicle in a first case where the predicted travel distance is equal to or larger than a predetermined threshold, or select the electric vehicle in a second case where the predicted travel distance is less than the threshold. With this aspect, it is possible to recommend the appropriate type of vehicle to the user in accordance with the predicted travel distance.

(3) In the above aspect, the selection unit may further generate, as list information, information on the vehicle that is rentable, and the notification unit may further notify the user of the list information. With this aspect, the user can select a vehicle to rent based on the list information and the recommended vehicle type.

The present disclosure can be implemented in various forms, which may include, for example, a computer program for causing a computer to execute the rental system and a non-transitory recording medium for recording such a computer program, in addition to the rental system stated above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle rental system according to a first embodiment;

FIG. 2 is a diagram illustrating an information input screen for generating usage information;

FIG. 3 is an internal block diagram of a server device;

FIG. 4 is a diagram illustrating recommended information; and

FIG. 5 is a diagram illustrating a second embodiment.

### DETAILED DESCRIPTION OF EMBODIMENTS

### A. First Embodiment

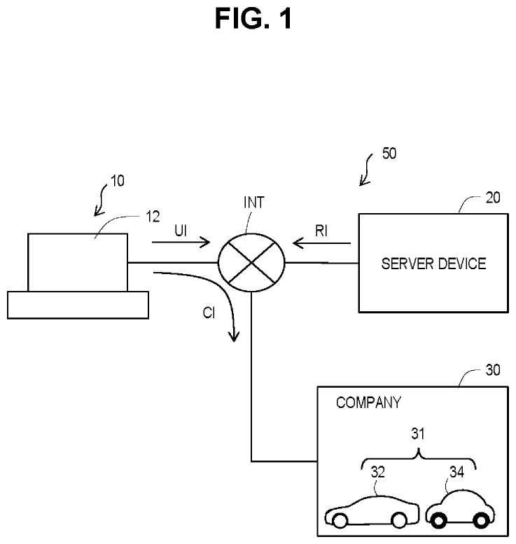

FIG. 1 is a diagram illustrating a rental system 50 of a vehicle 31 according to a first embodiment of the present disclosure. The rental system 50 includes an input terminal 10, a server device 20, and a company 30. The input terminal 10, the server device 20, and the company 30 are connected to each other via the Internet INT.

The input terminal 10 is a terminal operated by a user who rents the vehicle 31 for the purpose of using the vehicle for a certain period. The input terminal 10 may be, for example, a personal computer or a portable terminal such as a smartphone. The input terminal 10 has a display screen 12.

The server device 20 acquires usage information UI on use of a vehicle 31 by a user, which is input via the input terminal 10, and notifies the user of recommended information RI including a type of the vehicle 31 recommended based on the acquired usage information UI when the user rents the vehicle 31 from the company 30. Details of the server device 20 will be described later. The company 30 rents out the vehicle 31 to the user according to application information CI from the user, which is acquired via, for example, the input terminal 10. The company 30 has two types of vehicles 31 that can be rented out to users: fuel cell vehicles 32 and electric vehicles 34.

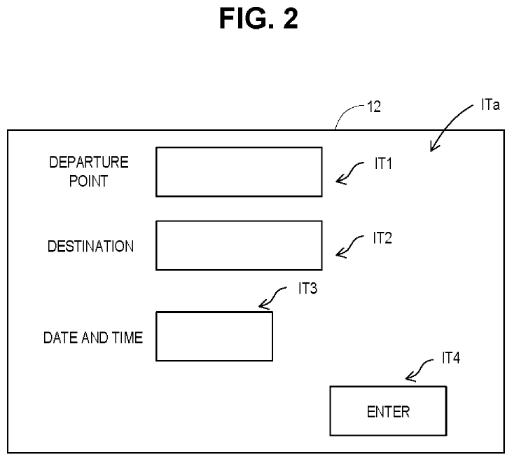

FIG. 2 is a diagram illustrating an information input screen ITa for generating the usage information UI. The information input screen ITa is displayed on the display screen 12 by connecting the input terminal 10 to a homepage of the company 30. The information input screen ITa includes an item IT1 for inputting a departure point of the vehicle 31, an item IT2 for inputting a destination of the vehicle 31, an item IT3 for inputting the date and time when the user uses the vehicle, and an item IT4 for determining the input contents. The user, for example, inputs addresses of the departure point and the destination, as well as the date and time when the user uses the vehicle 31 (for example, from 13:00 on April 12 to 20:30 on April 12), and then selects an enter button. Consequently, the usage information UI including the departure point, the destination, and the date and time when the user uses the vehicle is transmitted to the server device 20. In the usage information UI, the departure point information and destination information constitute route information on a predicted travel route of the vehicle 31. When the company 30 rents out the vehicle 31 to the user at a place where the vehicle 31 is stored (predetermined place), the address of the predetermined place may be pre-filled in the item IT1 for inputting the departure point of the information input screen ITa, or the item IT1 for inputting the departure point may be omitted. Further, the information input screen ITa may include an item for inputting one or more transit points.

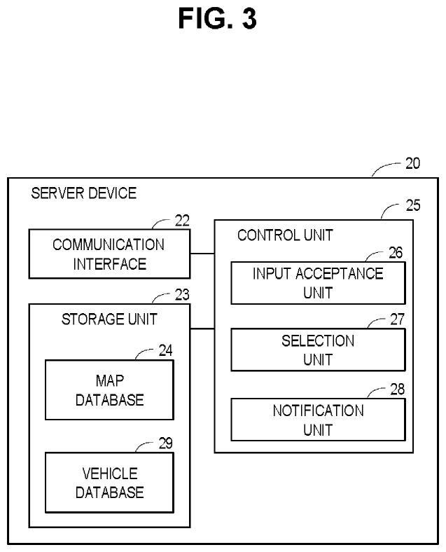

FIG. 3 is an internal block diagram of the server device 20. The server device 20 includes a communication interface 22, a storage unit 23, and a control unit 25. The communication interface 22 performs wired or wireless data communication with a communicable device such as the input terminal 10 or a terminal owned by the company 30.

The storage unit 23 may include, for example, ROM and RAM, and stores data such as various programs. The storage unit 23 may store, for example, a map database 24 and a vehicle database 29. The map database 24 stores network data for performing a route search from the departure point to the destination. The network data has nodes that represent specific points such as intersections and dead ends, and links representing roads that connect the nodes. The network data also stores a link length (distance) associated with each link. The vehicle database 29 stores the vehicles 31 that can be rented out by the company 30 and time zones in which those vehicles can be rented out. The vehicle database 29 is updated with information transmitted from the terminal of the company 30 to the server device 20 at predetermined intervals.

The control unit 25 functions as an input acceptance unit 26, a selection unit 27, and a notification unit 28 by executing various programs stored in the storage unit 23. The input acceptance unit 26 accepts an input of the usage information UI use of a vehicle 31 by a user via the communication interface 22.

The selection unit 27 selects a type of the vehicle 31, from among the electric vehicle 34 and the fuel cell vehicle 32, which is recommended for the user in accordance with the usage information UI accepted by the input acceptance unit 26. In the present embodiment, the selection unit 27 searches for a route from the departure point to the destination using the departure point information and the destination information, which are included in the predicted travel route of the usage information UI, and the map database 24.

The selection unit 27 searches for a route using, for example, Dijkstra's algorithm. The selection unit 27 predicts a travel distance of the vehicle 31 from the departure point to the destination by accumulating the distances associated with each of the links included in the searched route. The selection unit 27 may notify the user of a plurality of route candidates from the departure point to the destination and then predict the travel distance of the route candidate selected by the user.

The selection unit 27 selects the fuel cell vehicle 32 as the recommended vehicle 31 in a first case where the predicted travel distance is equal to or larger than a predetermined threshold, or alternatively, selects the electric vehicle 34 as the recommended vehicle 31 in a second case where the predicted travel distance is less than the threshold. It is preferable that the threshold is set to a value shorter than a cruising distance (for example, 650 kilometers) for which the fuel cell vehicle 32 can travel when it is fully charged. In addition, it is preferable that the threshold is set to a value shorter than a cruising distance (for example, 400 kilometers) for which the electric vehicle 34 can travel when it is fully charged. Generally, the cruising distance for which the fuel cell vehicle 32 can travel when it is fully charged is longer than the cruising distance for which the electric vehicle 34 can travel when it is fully charged. Therefore, when the predicted travel distance of the vehicle 31 is long, the fuel cell vehicle 32 is more suitable to the user than the electric vehicle 34.

Moreover, the selection unit 27 uses the date and time when the user uses the vehicle, included in the usage information UI, and the information of the vehicle database 29 to generate, as list information, information of the vehicles 31 that the company 30 can rent out at the date and time when the user uses the vehicle. The list information is information for specifying the vehicle 31, and includes, for example, vehicle type. In the other embodiment, the selection unit 27 may predict, as the travel distance, a continuous travel distance that does not pass through energy supply points such as a charging spot or a hydrogen station (for example, a distance from a departure point to an energy supply point, or a distance between the energy supply points) in the searched route. In this case, as in the present embodiment, the type of the vehicle 31 may be selected in accordance with the predicted travel distance.

The notification unit 28 sends a notification to the user by transmitting, to the input terminal 10, the recommended information RI (FIG. 1) including type information of the vehicle 31 selected by the selection unit 27 and the list information generated by the selection unit 27.

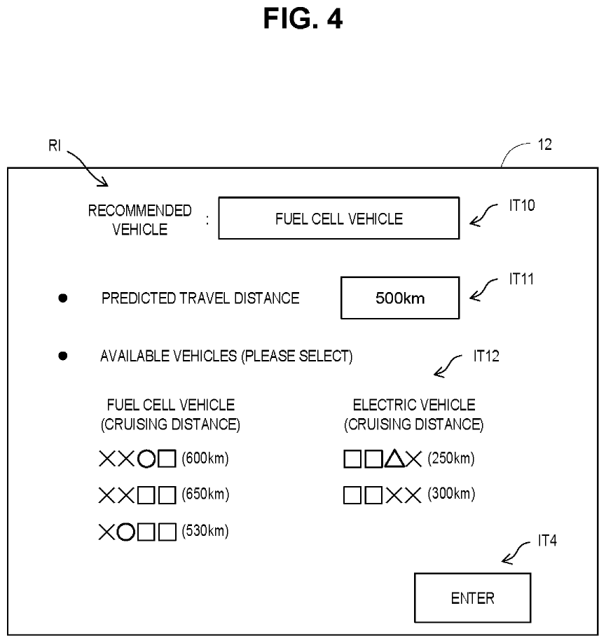

FIG. 4 is a diagram illustrating the recommended information RI. The recommended information RI includes an item IT10 for displaying the type of the recommended vehicle 31, an item IT11 for displaying the predicted travel distance of the vehicle 31, an item IT12 for displaying information on the available vehicle 31, and an item IT4 for determining the vehicle 31 to be rented out. The item IT12 displays the vehicle type of the available vehicle 31 and the cruising distance for which the vehicle can travel when it is fully charged for each vehicle type.

In FIG. 4, the type of recommended vehicle is the fuel cell vehicle 32. Moreover, the user selects the desired vehicle 31 from the vehicle type of the fuel cell vehicles 32 and the electric vehicles 34 listed in the item IT12 displaying the available vehicles 31, and then selects the enter button. The user can refer to the recommended vehicle, the travel distance of the item IT11 and the cruising distance of the item IT12 when selecting the vehicle 31 he/she desired to be used. When the enter button is selected, the information on the vehicle 31 selected by the user is transmitted to the company 30 via the server device 20, such that the vehicle 31 is rented out at the date and time when the user desires to use the vehicle.

According to the first embodiment, the selection unit 27 selects the type of the vehicle 31, from among the electric vehicle 34 and the fuel cell vehicle 32, which is recommended for the user in accordance with the usage information UI accepted by the input acceptance unit 26. Accordingly, it is possible to recommend the type of appropriate vehicle 31 to the user in accordance with the usage information UI. In particular, according to the first embodiment, it is possible to recommend the appropriate type of vehicle 31 to the user in accordance with the predicted travel distance. Generally, the travel distance for which the fuel cell vehicle 32 can travel when it is fully charged is longer than the travel distance for which the electric vehicle 34 can travel when it is fully charged. Therefore, the selection unit 27 selects the fuel cell vehicle 32 in the first case where the predicted travel distance is equal to or larger than the threshold, or alternatively, selects the electric vehicle 34 in the second case where the predicted travel distance is less than the threshold, whereby it is possible to recommend a suitable type of vehicle 31 to the user in accordance with the predicted travel distance. Further, as shown in FIG. 4, the notification unit 28 notifies the user of the list information (item IT12) generated by the selection unit 27, which is the information of the vehicle 31 that can be rented out. Accordingly, the user can select the vehicle to rent based on the list information and the type of the recommended vehicle 31.

### B. Second Embodiment

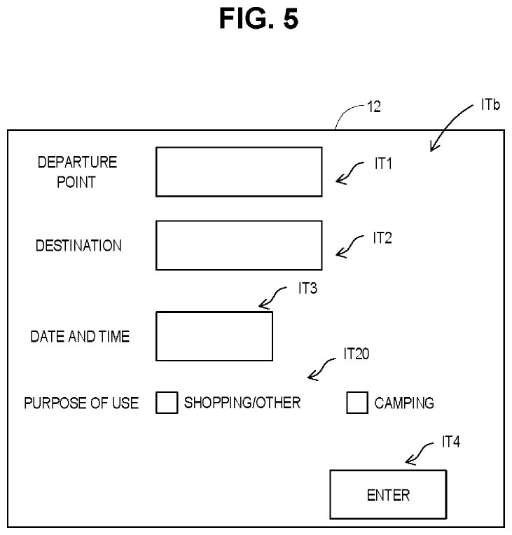

FIG. 5 is a diagram illustrating a second embodiment. FIG. 5 is a diagram illustrating an information input screen ITb displayed on the display screen 12. A difference between the second embodiment and the first embodiment is that, in the second embodiment, the selection unit 27 selects the type of the recommended vehicle 31 based on the purpose of use as the usage information UI. Since the other elements are the same in the second embodiment and the first embodiment, the same reference numerals are given to the same configurations and the description thereof will be omitted.

In the first embodiment, the selection unit 27 selects the type of the recommended vehicle 31 based on the route information on the predicted travel route, however the disclosure is not limited thereto and other usage information may be used to select the type of the recommended vehicle 31. In the second embodiment, the selection unit 27 selects the type of the recommended vehicle 31 based on the purpose of use as the usage information UI. The information input screen ITb has an item IT20 for inputting the purpose of use in addition to the items IT1 to IT4 described in the first embodiment. In the item IT20, “shopping/other” and “camping” are displayed as being selectable for the purpose of use of the vehicle 31.

The selection unit 27 selects the recommended vehicle 31 based on the purpose of use input via the display screen 12. In particular, the selection unit 27 selects the electric vehicle 34 when the purpose of use is “shopping/other”, or alternatively, selects the fuel cell vehicle 32 when the purpose of use is “camping” regardless of the predicted travel distance. In other words, the selection unit 27 selects the fuel cell vehicle 32 having a larger power supply capacity than that of the electric vehicle 34 in a case where the purpose of use is that electricity is likely to be supplied from the vehicle 31 to an external load (for example, lighting device). On the other hand, the selection unit 27 selects the electric vehicle 34 in a case of the purpose of use in which electricity is less likely to be supplied from the vehicle 31 to an external load. The notification unit 28 notifies the user of the type of the vehicle 31 selected by the selection unit 27.

According to the second embodiment, it is possible to recommend the appropriate type of vehicle 31 to the user in accordance with the purpose of use. Generally, the fuel cell vehicle 32 has a larger power supply capacity than that of the electric vehicle 34. Therefore, the selection unit 27 selects the fuel cell vehicle 32 in a case where electricity is likely to be supplied from the vehicle 31 to an external load, or alternatively, selects the electric vehicle 34 in a case where electricity is less likely to be supplied from the vehicle 31 to an external load, whereby it is possible to recommend a suitable type of vehicle 31 to the user in accordance with the purpose of use. The type of purpose of use displayed in the item IT20 is not limited thereto. For example, “moving” is displayed so as to be selected in the item IT20 as the purpose of use. The selection unit 27 selects the fuel cell vehicle 32 in a case where the purpose of use is “moving” regardless of the predicted travel distance. Generally, the fuel cell vehicle 32 has a larger maximum output than that of the electric vehicle 34. Therefore, the fuel cell vehicle 32 is selected by the selection unit 27 in a case where it is assumed that heavy luggage is loaded on the vehicle 31, such that the user can select a suitable type of vehicle 31 in accordance with the purpose of use.

### C. Other Embodiments

### C-1. Other Embodiment: First

The first embodiment and the second embodiment may be used in combination. In other words, the selection unit 27 may select a type of the vehicle 31, from among the electric vehicle 34 and the fuel cell vehicle 32, which is recommended for the user in accordance with the route information and purpose of use information, included in the usage information UI. For example, the selection unit 27 may select the fuel cell vehicle 32 in a case where the predicted travel distance is equal to or larger than the threshold or in a case where the purpose of use is “moving”, or alternatively, select the electric vehicle 34 in a case where the predicted travel distance is less than the threshold and the purpose of use is “traveling/other”.

### C-2. Other Embodiment: Second

Information that the selection unit 27 uses for choosing the recommended type of vehicle 31 is not limited to the travel distance or the purpose of use stated above. For example, the selection unit 27 searches for a route from the departure point to the destination by, for example, Dijkstra's algorithm, and considers the number of hydrogen stations or the number of charging spots of the electric vehicle 34 on or around the searched route as a factor upon selecting the vehicle. For example, the selection unit 27 may select the electric vehicle 34 even in a case where the predicted travel distance is equal to or larger than the threshold but there are a predetermined number of charge spots on or around the searched route without the hydrogen station. Further, for example, the selection unit 27 may select the fuel cell vehicle 32 in a case where the travel distance (continuous travel distance) of the vehicle 31 to the energy supply point such as the charging spot or the hydrogen station is long, or alternatively, select the electric vehicle 34 in a case where the continuous travel distance is short, for the route from the departure point to the destination. For example, in a case where a highway exists on the route from the departure point to the destination, the continuous travel distance tends to be long. Therefore, in a case where the highway exists on the route, the selection unit 27 may select the fuel cell vehicle 32 regardless of the continuous travel distance.

Further, for example, the selection unit 27 may select the type of the recommended vehicle 31 in accordance with the outside air temperature by predicting or acquiring from another server device the outside air temperature at the date and time when the user desires to use the vehicle. In a case where the outside air temperature is high or low, the air conditioner of the vehicle 31 is likely to be used. In this case, the fuel cell vehicle 32 tends to have a higher fuel consumption reduction rate than that of the electric vehicle 34. Therefore, the selection unit 27 may select the electric vehicle 34 as the recommended vehicle 31 in a case where the outside air temperature is high or low.

### C-3. Other Embodiment: Third

The rental system 50 may include an award unit that gives a privilege to the user who has used a zero emission vehicle such as the fuel cell vehicle 32 or the electric vehicle 34. The award unit offers, for example, a discount when the vehicle 31 is rented next time, prizes, awards, points, or preferential use of a parking lot to the user in accordance with the use time and the travel distance of the zero emission vehicle. These awards promote the use of zero emission vehicles.

### C-4. Other Embodiment: Fourth

In the embodiment stated above, the notification unit 28 may notify the user of the advantages of the type of the recommended vehicle 31. This notification may be made by, for example, displaying the advantages on the display screen 12. In a case where the type of the recommended vehicle 31 is the fuel cell vehicle 32, the notification unit 28 displays on the display screen 12 the advantages as a message, for example, that the fuel cell vehicle 32 discharges water only. Moreover, for example, in a case where the type of the recommended vehicle 31 is the fuel cell vehicle 32, the notification unit 28 may display on the display screen 12 the advantages as a message, for example, that the user will be awarded depending on use of hydrogen and can travel in the priority driving lane. Further, the notification unit 28 may notify the user not only of the advantages of the type of the recommended vehicle 31 but also the disadvantages thereof. Consequently, in notifying the user of the advantages and disadvantages of the type of the recommended vehicle 31, the user can refer to the notification when he/she rents the vehicle 31.

### C-5. Other Embodiment: Fifth

In the embodiment stated above, the selection unit 27 may determine the threshold used to select the type of the vehicle 31 as follows. In particular, the threshold may be set to a value equal to or smaller than the smallest value of the cruising distance which the fuel cell vehicle 32 that can be rented out by the company 30 on the date and time when the user uses the vehicle can travel when it is fully charged. Further, the threshold may be set to a value larger than the maximum value of the cruising distance which the electric vehicle 34 that can be rented out by the company 30 on the date and time when the user uses the vehicle can travel when it is fully charged.

The present disclosure is not limited to the embodiments stated above, and can be implemented with various configurations without departing from the spirit of the disclosure. For example, the technical features of the embodiment corresponding to the technical features in each mode described in the summary of the disclosure may be appropriately replaced or combined in order to address some or all of the technical shortcomings, or in order to achieve some or all of the technical effects. If the technical features are not described as essential in this specification, they can be deleted as appropriate.

What is claimed is:

1. A vehicle rental system, comprising:
an input acceptance unit configured to accept input of usage information on use of a vehicle by a user;
a selection unit configured to select a type of the vehicle, from among an electric vehicle and a fuel cell vehicle, which is recommended for the user according to the usage information accepted by the input acceptance unit; and
a notification unit configured to notify the user of the type of the vehicle selected by the selection unit.

2. The vehicle rental system according to claim 1, wherein:
the usage information includes route information on a predicted travel route of the vehicle; and
the selection unit is configured to:
predict a travel distance of the vehicle using the predicted travel route; and
select the fuel cell vehicle in a first case where the predicted travel distance is equal to or larger than a predetermined threshold, or select the electric vehicle in a second case where the predicted travel distance is less than the threshold.

3. The vehicle rental system according to claim 1, wherein:
the selection unit is configured to further generate, as list information, information on the vehicle that is rentable; and
the notification unit is configured to further notify the user of the list information.
